(19) United States
(12) Patent Application Publication
(10) Pub. No.: US 2008/0168419 A1
(43) Pub. Date: Jul. 10, 2008

(54) OPTICAL PROXIMITY CORRECTION IMPROVEMENT BY FRACTURING AFTER PRE-OPTICAL PROXIMITY CORRECTION

(75) Inventors: MARTIN BURKHARDT, White Plains, NY (US); Nakgeuon Seong, Allen, TX (US)

Correspondence Address: LAW OFFICE OF DELIO & PETERSON, LLC., 121 WHITNEY AVENUE, NEW HAVEN, CT, 06510, US

(73) Assignee: International Business Machines Corporation, Armonk, NY (US)

(21) Appl. No.: 11/619,749

(22) Filed: Jan. 4, 2007

(51) Int. Cl. G06F 17/50

(52) U.S. Cl. 716/21

(57) ABSTRACT

A method for fabricating a mask used to make integrated circuits is provided using an improved OPC process whereby a pre-fracturing OPC process is performed on the target design of the integrated circuit. The pre-fractured OPC design is then fractured and a post-fracturing OPC process performed to make the final mask. Either rule-based OPC or model-based OPC processes can be used for both of the OPC steps or each step can be either side-based or model-based OPC.

### BACKGROUND OF THE INVENTION

1. Field of the Invention

This invention generally relates to VLSI circuit design and more specifically relates to improving the optical proximity correction process used to make the lithographic mask.

2. Description of Related Art

Integrated circuits including very large scale integrated (VLSI) complementary metal oxide semiconductor (CMOS) chips are manufactured on a silicon wafer by a sequence of material additions (i.e., low pressure chemical vapor depositions, sputtering operations, etc.), material removals (i.e., wet etches, reactive ion etches, etc.), and material modifications (i.e., oxidations, ion implants, etc.). These physical and chemical operations interact with the entire wafer. For example, if a wafer is placed into an acid bath, the entire surface of the wafer will be etched away. In order to build very small electrically active devices on the wafer, the impact of these operations has to be confined to small, well-defined regions.

Lithography in the context of VLSI manufacturing of CMOS devices is the process of patterning openings in photosensitive polymers (sometimes referred to as photoresists or resists) which define small areas in which the silicon base (or other) material is modified by a specific operation in a sequence of processing steps. The manufacturing of CMOS chips involves the repeated patterning of photoresist, followed by an etch, implant, deposition, or other operation, and ending in the removal of the expended photoresist to make way for a new resist to be applied for another iteration of this process sequence.

The basic lithography system as is well-known in the art consists of a light source, a stencil, or photomask containing the pattern to be transferred to the wafer, a collection of lenses, and a means for aligning existing patterns on the wafer with patterns on the mask.

Conventional photomasks consist of chromium patterns on a quartz plate, allowing light to pass wherever the chromium is removed from the mask. Light of a specific wavelength is projected through a mask onto the photoresist coated wafer, exposing the resist wherever hole patterns are placed on the mask. Exposing the resist to light of appropriate wavelength causes modifications in the molecular structure of the resist polymers which allows a developer chemical to dissolve and remove the resist in the exposed areas. Conversely, negative resist systems allow only unexposed resist to be developed away.

These conventional photomasks are commonly referred to as chrome on glass (COG) binary masks. The perfectly square step function of forming the mask patterns on the wafer, however, exists only in the theoretical limit of the exact mask plane. In the image plane, such as in the wafer plane, diffraction effects will cause images to exhibit a finite image slope. At small dimensions, that is, when the size and spacing of the images to be printed are small, electric field vectors of nearby images will interact and add constructively. The resulting light intensity curve between features is not completely dark, but exhibits significant amounts of light intensity created by the interaction of adjacent features. The resolution of an exposure system is limited by the contrast of the projected light image, that is the intensity difference between adjacent light and dark features. An increase in the light intensity in nominally dark regions will eventually cause adjacent features to print as one combined structure rather than discrete images.

Sub-wavelength lithography, where the size of printed features is smaller than the exposure wavelength, places a tremendous burden on the lithographic process. Distortions of the intended images inevitably arise, primarily because of the nonlinearities of the imaging process and the nonlinear response of the photoresist. Two of the most prominent types of distortions are the wide variation in the linewidths of identically drawn features in dense and isolated environments (dense-iso bias) and the line-end pull-back or line-end shortening (LES) from drawn positions. The former type of distortion can cause variations in circuit timing and yield, whereas the latter can lead to poor current tolerances and higher probabilities of electrical failure.

Optical proximity correction or optical proximity compensation (OPC) is the well-known technology used to compensate for these types of distortions. OPC is loosely defined as the procedure of compensating (pre-distorting) the mask layout of the critical IC layers for the lithographic process distortions to follow. This is done with specialized OPC software. In the heart of the OPC software is a mathematical description of the process distortions. This description can either be in the form of simple shape manipulation rules, in which case the OPC is referred to as “rule-based OPC,” or a more detailed and intricate process model for a “model-based OPC.” The OPC software automatically changes the mask layout by moving segments of line edges and adding extra features that (pre-) compensate the layout for the distortions to come. Although after OPC has been performed the mask layout may be quite different than the original (before OPC) mask, the net result of this procedure is a printed pattern on the wafer that is closest to the IC designer's original intent. There are commercially available software tools that perform OPC on a full-chip scale. OPC relies heavily on speedy calculations of the image intensity at selected points of the image field.

In this method, changes are made to the binary mask layout so that it will print more clearly. Because of the limited resolution of current photolithographic tools (i.e., steppers), patterns defined on the photomask are transferred into the resist on the wafer with some distortions referred to as optical proximity effects. The main consequences in term of line width control are: corner rounding, difference between isolated and semi-isolated or dense patterns, lack of CD linearity where small features print even smaller than their expected size compared to large features and line end shortening where the length of a line having a small line width becomes smaller than its expected size. Moreover, optical proximity effects are convoluted with subsequent processing step distortions like resist processing, including dry etch and wet etch proximity effects.

In order to achieve a sufficient line width control at the wafer level, the mask designs are corrected to proximity effects, typically re-entrant and outside serifs are used to correct rounding and the edges of patterns are moved to correct line width errors.

The masks used to expose the photoresist layer are typically processed by an optical proximity correction (OPC) process to alleviate problems caused by the diffraction of the exposure radiation at the feature edges, and over-etching of the photoresist at the ends of the features. The OPC process adds elements such as serifs and hammerheads to the original polygons. These added elements (and some of the original polygons) can cause problems during the mask writing process because the mask writing equipment can typically print only rectangles. Hence, after the OPC process, mask features are typically “fractured” so that each exposure element is a rectangle.

Rule-based OPC uses a set of fixed rules for geometrically manipulating the data set. For instance, to minimize line end pull-back, “hammer heads” or “bunny-ears” can be added to the line ends, depending on other nearby structures. Model-based OPC uses a set of modeling principles that incorporates predetermined behavior data to drive geometric manipulation of the data set. As indicated, the OPC correction process can use either rule-based corrections or model-based corrections, or a combination of both techniques. In addition, the rules and/or models can vary from iteration to iteration. For example, on a first iteration, rule-based OPC techniques can dominate the simulation process. As the iteration counter increases, model-based OPC techniques can play a larger role in the simulation process. In addition, as the iteration counter increases, a damping technique can be used to avoid repeated over-correction of the data set followed by under-correction of the data set. The OPC process can be conducted using specified conditions, such as best focus, a certain dose, or other illumination condition.

The OPC process can manipulate segments (also referred to in the art as fragments) of each edge of each geometrical shape on the mask to arrive at a corrected data set corresponding to a corrected reticle. That is, each edge can be broken down into a plurality of segments that can be moved “inward” or “outward” depending on the rules and/or models applied during the OPC process. It is noted that the segments should not be shorter than can be physically achieved on the reticle.

Broadly stated, in optical proximity correction, a design pattern is fractured into edges using rules that are determined during job setup. During the optical proximity correction, the best placement of these edges is determined either using an empirically determined rule or a physical model that is calibrated on empirical data. The fracturing is not adjusted during this step. For corrections that modify the patterns only slightly, this is usually sufficient. For large corrections, the fracturing done in this way can be deficient. For example, the movement of the edges that were determined during initial fracturing may be limited due to mask rule violations. Mask rules are rules that are imposed by the mask vendor in order to be able to manufacture and then inspect the mask for defects.

The current process of optical proximity correction has the potential to create problems in that the fracturing before OPC can create situations which cause the OPC to run into mask rule limitations. These mask rules are imposed upon the OPC by the limitations of mask building. For example, the mask maker may require that a minimum chrome line can only be 50 nm at wafer level (or 200 nm at mask level for a 4× demagnification system). Even though an optimum solution for OPC could be found, the mask rule checks will prevent the OPC to converge to this solution.

FIG. 3 and FIGS. 4A, 4B, and 4C show the problem of the prior art. FIG. 4A shows the target design of two adjacent rectangles that the designer wants on the chip. FIG. 4B shows fracturing that is done prior to OPC—the oval shape indicates the approximate printing of the resist without OPC and the horizontal lines the points of fracturing. FIG. 4C shows the OPC result which was affected by mask rule checks, e.g., the oval shape indicates the approximate printing of the resist after OPC, the dashed line the target and the solid lines the feature shape on the mask. Note that the oval shape does not come close to the target in length because the OPC was prevented from moving the mask edges because of MRC rule checks. FIGS. 4A-4C will be discussed below in detail in connection with the method of the invention.

FIG. 3 is a flow chart of the above prior art process and is shown generally as numeral 100. In step 102 the target layout is determined. In step 104 the target is fractured and in step 106, OPC using MRC rules is performed. The process ends in step 108.

### SUMMARY OF THE INVENTION

Bearing in mind the problems and deficiencies of the prior art, it is therefore an object of the present invention to provide a method for fabricating a mask for making integrated circuits using a pre-fracturing optical proximity correction process and a post-fracturing optical proximity correction process.

It is another object of the present invention to provide a computer program product comprising a computer readable storage medium having stored therein instructions executable by the computer for fabricating a mask for making integrated circuits.

Still other objects and advantages of the invention will in part be obvious and will in part be apparent from the specification.

The above and other objects, which will be apparent to those skilled in the art, are achieved in the present invention, which is directed to a method for fabricating a mask for making integrated circuits comprising the steps of:

creating a schematic circuit design consisting of individual devices coupled together to perform a certain function or set of functions;

performing a pre-fracturing optical proximity correction (OPC) process on the individual devices of the design;

fracturing the individual devices of the design; and

performing OPC on the fractured design to form an OPC modified design on the mask.

The OPC process used to fabricate the mask can be rule-based or model-based for both steps or for each OPC step either rule-based or model-based can be used.

In another aspect, the present invention provides a program storage device readable by a machine, tangibly embodying a program of instructions executable by the machine to perform the aforementioned method steps for designing a mask using a pre-fracturing and a post-fracturing optical proximity correction process.

In a further aspect, the present invention provides an article of manufacture comprising a computer-usable medium having computer readable program code means for practicing the aforementioned method steps.

### BRIEF DESCRIPTION OF THE DRAWINGS

The features of the invention and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a flow diagram illustrating a method of the invention for fabricating a mask used to make integrated circuits.

FIGS. 2A-2D show a method of the invention for making a mask having target features.

FIG. 3 is a flow diagram illustrating a method of the prior art for fabricating a mask used to make integrated circuits.

FIGS. 4A-4C show a method of the prior art for making a mask having target features.

### DESCRIPTION OF THE PREFERRED EMBODIMENT(S)

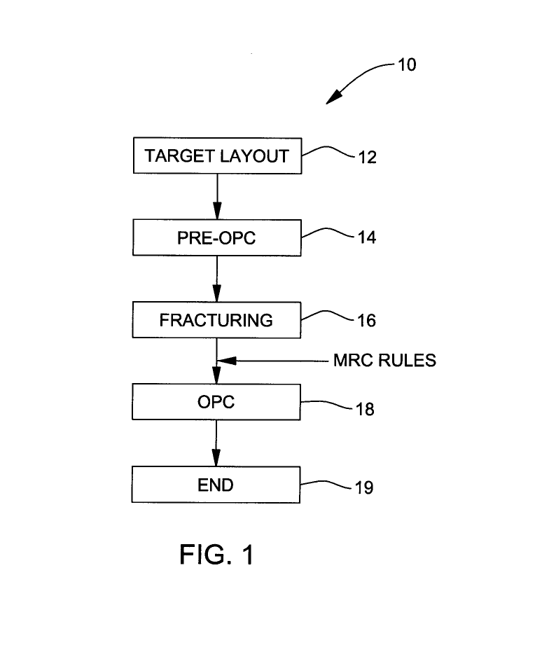

In describing the preferred embodiment of the present invention, reference will be made herein to FIGS. 1-4C of the drawings in which like numerals refer to like features of the invention.

Accurate definition of mask patterns having line widths less than the wavelength of light is generally implemented using OPC (optical proximity correction), a collection of techniques for correcting beforehand the shape of mask patterns, to allow for pattern deformations on the wafer caused by the so-called optical proximity effect. This collection of OPC techniques is also called PPC (process proximity effect correction). A typical OPC tool of this type is rule-based OPC.

Rule-based OPC is implemented as follows: a test-use mask pattern is prepared using test patterns representing all patterns that are permitted by design. The test patterns are transferred through the mask pattern onto the wafer for pattern etching, whereby a test-use wafer is produced.

The pattern geometry on the test-use wafer is then measured. The measured data, together with design data from the test-use mask pattern, are used as a basis for generating rule-based OPC, i.e., a collection of design rules for determining bias data to be added to mask pattern design data. The mask pattern is then corrected using the rule-based OPC. The correction takes place at a mask pattern layout stage in the CAD process. The mask fabricated through OPC is called the OPC mask.

Apart from rule-based OPC, there is another set of corrective techniques called model-based or simulation-based OPC.

This type of proximity effect correction involves generating a simulation-based OPC model (also called a kernel or a process model) that represents a pattern transfer process allowing for the optical proximity effect based on the measurements of a limited number of test patterns prepared beforehand. Differences in shape between the mask pattern and the pattern geometry transferred through the mask pattern onto the wafer are simulated by the simulation-based OPC model. The results of the simulation are used to correct the mask pattern. Model-based OPC is calibrated using physical structures just as much as rule-based OPC. The model is a physical model but there is always a fitting component that comprehends resist effects, process effects, and the like.

OPC is a well-known technique used in the fabrication of electronic components such as integrated circuits and need not be detailed herein. A number of U.S. patents describe OPC including U.S. Pat. Nos. 5,682,323; 6,854,104; 6,829,380; 6,928,636; and 6,934,929. These patents are hereby incorporated by reference.

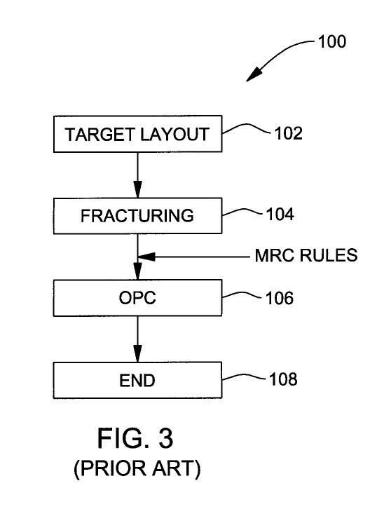

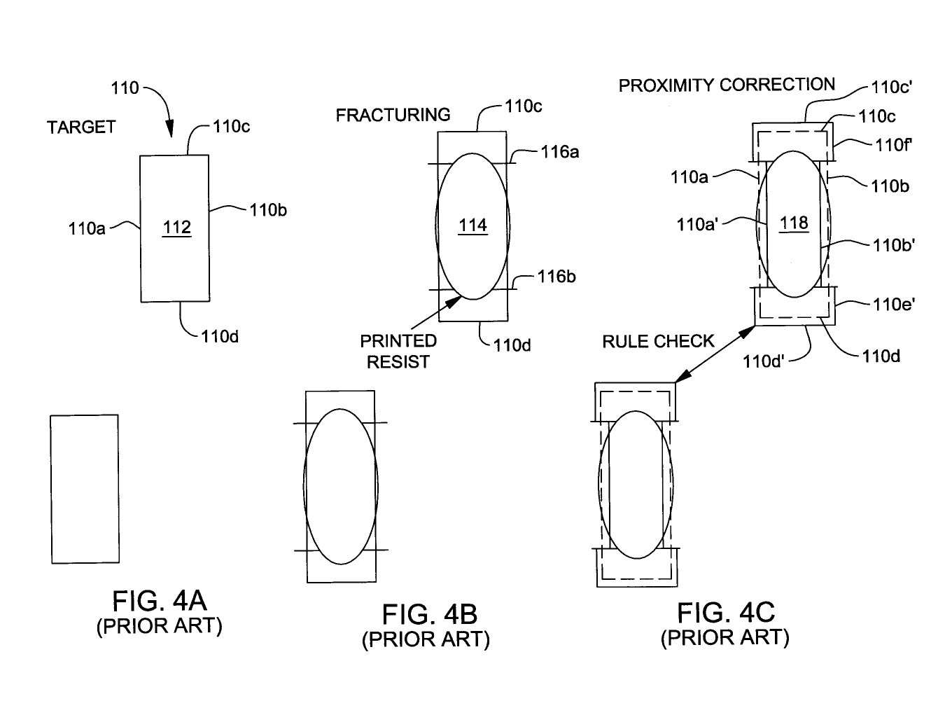

Referring first to the prior art FIG. 3 and FIGS. 4A-4C, the prior art method is shown and how the prior art method forms a mask feature for generating a target feature on the semiconductor device.

In the flow sheet of FIG. 3 shown generally as numeral 100, a target layout is determined in step 102. The target is fractured in step 104 and OPC is performed under consideration of MRC rules in step 106. The method ends in step 108.

In FIG. 4A two adjacent target features are shown generally as numeral 110 with the target having sides 110a, 110b, 110c, and 110d. The sides define a target feature 112. The target feature 112 is the target that the semiconductor designer wants on the chip.

In FIG. 4B the oval-shape 114 indicates the approximate printing on the resist without an OPC procedure. The target is fractured shown as lines 116a and 116b.

In step 4C OPC is performed on the fractured feature of FIG. 4B. The target feature is shown by the dotted lines and the mask feature generated by the OPC procedure as the solid rectangular lines, numerals 110a′-110f′. The oval-shape 118 indicates the approximate printing on the resist after the OPC procedure and it should be noted that the oval shape does not come close to the target in length because the OPC was prevented from moving the mask edges because of MRC rules.

FIG. 1 shows a flow chart of the subject invention generally as numeral 10. In step 12 a target layout is prepared and in step 14 a pre-OPC procedure is performed on the target layout. The pre-OPC procedure is performed before any fracturing of the target layout. In step 16 fracturing is then performed and in step 18 the OPC procedure is performed. The process ends in step 19.

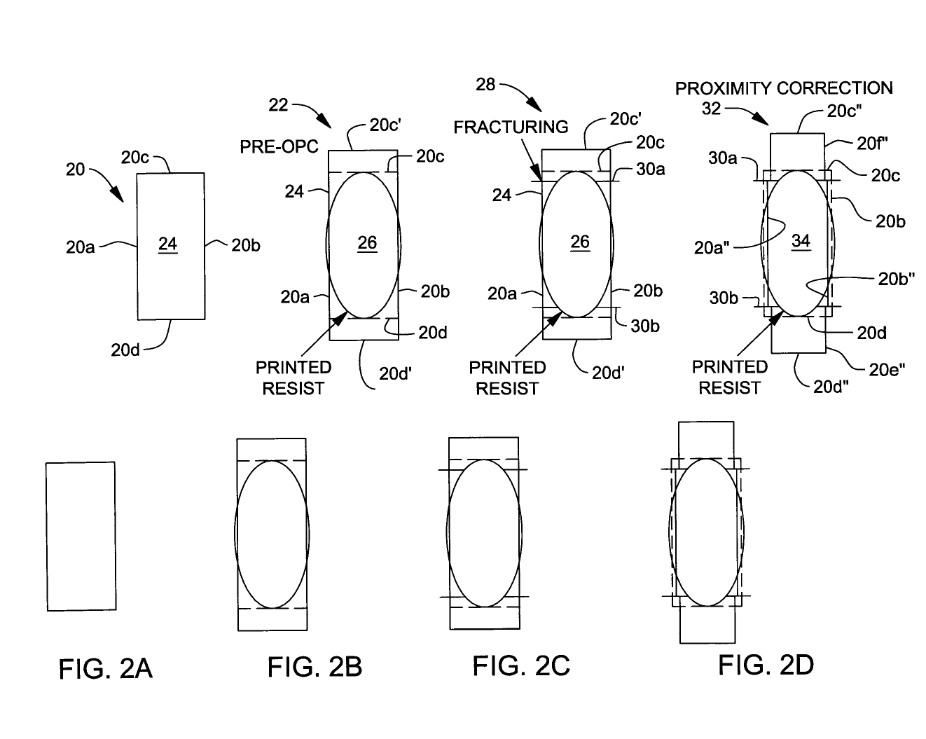

Referring now to FIGS. 2A-2D the method of the invention can be shown. In FIG. 2A a target layout is shown generally as numeral 20 and comprises adjacent rectangular shapes having sides 20a, 20b, 20c, and 20d. The sides enclose a target area 24.

In FIG. 2B the results of a pre-OPC procedure are shown as numeral 22. The pre-OPC procedures forms a pre-OPC shape 22, bounded by solid lines 20a, 20b, and 20c′ and 20d′. This would form a printed oval shape 26 which indicates the approximate shape of the photoresist on the wafer after pre-OPC if the solid line shape was formed on a mask and printed. As can be seen the image is still not as desired since it is too wide at the center of the target. Note also that the mask design 22 has been lengthened so that the ends are now 20c′ and 20d′. The pre-OPC procedure was performed using model-based OPC. Calibre solid by Mentor Graphics Corporation was used.

FIG. 2C shows the fracturing of the pre-OPC geometries generally as numeral 28. The target feature is fractured along lines 30a and 30b and was performed based on rules. For example, fracturing is performed a certain distance, e.g., 40 nm from a corner along a long side and no fracturing on a short side (line end). Fracturing is typically done within the OPC tool such as for example, using Calibre sold by Mentor Graphics Corporation, to do both fracturing and OPC.

FIG. 2D shows the final mask layout which achieves good printing in the resist and does not run into mask rule checks of the OPC procedure. Thus, the target layout on the mask is now defined by the solid rectangular lines 20a″-20f″. The target feature is still shown by dotted lines 20a-20d. The final layout shown by oval 34 is the approximate shape of the photoresist on the wafer obtained by the mask feature defined by the solid lines 20a″-20f″. This printed feature is closer to the target design obtained by the prior art method shown by FIGS. 3 and 4A-4C. The post-OPC procedure was performed using model-based OPC using Calibre.

While the present invention has been particularly described, in conjunction with a specific preferred embodiment, it is evident that many alternatives, modifications, and variations will be apparent to those skilled in the art in light of the foregoing description. It is therefore contemplated that the appended claims will embrace any such alternatives, modifications, and variations as falling within the true scope and spirit of the present invention.

Thus, having described the invention, what is claimed is:

1. A method for fabricating a mask for making integrated circuits comprising the steps of:
creating a schematic circuit design consisting of individual devices coupled together to perform a certain function or set of functions;
performing a pre-fracturing optical proximity correction (OPC) process on the individual devices of the design;
fracturing the individual devices of the design; and
performing OPC on the fractured design to form an OPC modified design on the mask.

2. The method of claim 1 wherein the OPC process for both OPC steps is rule-based.

3. The method of claim 1 wherein the OPC process for both OPC steps is model-based.

4. The method of claim 1 wherein the OPC process for each OPC step is either rule-based or model-based.

5. A program storage device readable by a machine, tangibly embodying a program of instructions executable by the machine to perform method steps for fabricating a mask, wherein the mask is to be used to project an image of an integrated circuit design, said method steps comprising:
creating a schematic circuit design consisting of individual devices coupled together to perform a certain function or set of functions;
performing a pre-fracturing optical proximity correction (OPC) process on the individual devices of the design;
fracturing the individual devices of the design; and
performing OPC on the fractured design to form an OPC modified design on the mask.

6. The device of claim 5 wherein the OPC process for both OPC steps is rule-based.

7. The device of claim 5 wherein the OPC process for both OPC steps is model-based.

8. The device of claim 5 wherein the OPC process for each OPC step is either rule-based or model-based.

9. An article of manufacture comprising a computer-usable medium having computer readable program code means embodied therein for practicing the method steps of claim 1 to fabricate a mask.

10. The article of claim 9 wherein the method steps of claim 2 are used.

11. The article of claim 9 wherein the method steps of claim 3 are used.
